(19) United States
(12) Patent Application Publication
(10) Pub. No.: US 2017/0157847 A1
(43) Pub. Date: Jun. 8, 2017

(54) THREE-DIMENSIONAL OBJECT SHAPING DEVICE AND THREE-DIMENSIONAL OBJECT SHAPING METHOD

(71) Applicant: MIMAKI ENGINEERING CO., LTD., Nagano (JP)

(72) Inventor: Hirofumi HARA, Nagano (JP)

(73) Assignee: MIMAKI ENGINEERING CO., LTD., Nagano (JP)

(21) Appl. No.: 15/323,737

(22) PCT Filed: Jul. 3, 2015
(86) PCT No.: PCT/JP2015/069293

§ 371 Date: Jan. 4, 2017

(30) Foreign Application Priority Data
Jul. 7, 2014 (JP) 2014-139659

(51) Int. Cl. B29C 67/00; B33Y 10/00; B33Y 50/02; B33Y 30/00

(52) U.S. Cl. CPC B29C 67/0062; B33Y 30/00; B33Y 10/00; B29C 67/0088; B33Y 50/02; B29K 2105/0058

(57) ABSTRACT

A three-dimensional object shaping device is provided and includes three-dimensional shape forming heads which discharge droplets of ultraviolet curing-type inks, a controller, and ultraviolet light sources. The controller prompts the three-dimensional shape forming heads and the ultraviolet light sources to carry out: a layered three-dimensional object forming operation, which forms and layers multiple layers that covers a preset region by curing an ultraviolet curing-type ink to form a layered three-dimensional object constituting a part of the three-dimensional object, wherein the layered three-dimensional object has steps generated by layering at least a part of multiple layers made of the ultraviolet curing-type ink; and an irregularities forming operation, which is an exemplified step coating layer forming operation of forming layers made of the ultraviolet curing-type ink on at least the steps in the layered three-dimensional object. A coloring head colors the three-dimensional object after the step irregularities forming operation performed is over.

### TECHNICAL FIELD

This invention relates to a three-dimensional object shaping device and a three-dimensional object shaping method.

### BACKGROUND ART

In recent years, 3D printers structured to shape three-dimensional objects are increasingly used in a variety of applications. In the meantime, various methods are known to shape three-dimensional objects using ultraviolet curing-type inks (UV-curable inks) (for example, patent literature 1).

### CITATION LIST

### Patent Literature

Patent Literature 1: Japanese Patent No. 4420685

### SUMMARY

### Technical Problems

Such 3D printers can shape three-dimensional objects in variously different shapes. On the other hand, the conventional 3D printers structurally complicated are generally high-priced devices. This has so far been a bottleneck in popularizing the 3D printers among the consumers. Under the circumstances, simplified devices for and methods of shaping three-dimensional objects have been desirably accomplished. This invention is directed to providing a three-dimensional object shaping device and a three-dimensional object shaping method that may deliver a solution to the issue.

In an attempt to shape a colored three-dimensional object using a 3D printer, a color reproducible range may be often narrower than in making prints using two-dimensional (2D) printers that are now predominantly used. Therefore, it is also desirable to ensure a broader color reproducible range in the pursuit of simpler and easier three-dimensional object shaping techniques.

### Solutions to the Problems

The inventors of this application, through their studies and researches on simpler and easier three-dimensional object shaping techniques, first came up with the idea of expressing the height of a target object by accumulating ink layers made of ultraviolet curing-type inks.

As briefly described earlier, the conventional inkjet printers can build a three-dimensional structure by accumulating the ink layers made of the ultraviolet curing-type inks. For example, one piece of data referred to as “data for layered finish” is provided, and the inks are deposited in layers in the same region repeatedly about 2 to 30 times based on the data. Then, a three-dimensional structure to a certain height (for example, approximately 6 mm) is obtainable. The three-dimensional object, after its three-dimensional structure is built, may be colored by having its surface subjected to color printing. The three-dimensional shape formed in this manner, however, can only express simple irregularities.

In the context of this fact, the inventors of this application discussed the possibilities of shaping objects in more complicated shapes by layering ink layers formed correspondingly to different pieces of data, instead of layering the ink layers in the same region using the same data. Specifically, the inventors contemplated how to shape three-dimensional objects in more complicated shapes, unlike any conventional objects that can only express simple irregularities. To this end, they prepared different pieces of data in accordance with a photograph and/or data representing a three-dimensional object to be shaped and layered a plurality of ink layers formed based on the respective pieces of data.

However, layering the ink layers in this manner may leave steps in inter-layer boundaries. As a result, the three-dimensional object obtained may have an unnatural shape. In an attempt to three-dimensionally reproduce a natural object, such as a landscape or an animal, based on a picture of the natural object, such steps, if generated in the process of layering the layers, may have their contours stand out, possibly spoiling the visual impression of an obtained three-dimensional object.

To address this issue, the inventors of this application found out through their studies that an effective solution could be forming, as well as the ink layers originally formed, additional ink layers so as to overlap the steps generated between the layered ink layers. By forming the ink layers overlapping the steps, the steps, as if they were snow-capped roof tiles, may be expected to prevent their contours from standing out. This may be a very promising manner of shaping a three-dimensional object presenting a natural appearance.

Further, the inventors of this application studied on how to form the ink layers so as to overlap the steps. They discussed that further forming fine irregularities correspondingly to details of a target object's image to be expressed by a three-dimensional object would allow the three-dimensional object shaped to present a more natural appearance. The target object's image to be expressed by a three-dimensional object may be an image printed at the time of coloring the three-dimensional object or an image obtained by subjecting the image to a predetermined image process (for example, gray-scaled image).

By forming the irregularities correspondingly to details of the target object's shape so as to overlap the steps between the layered layers, the steps may be less noticeable, conducing to a more natural appearance of the three-dimensional object. When a three-dimensional object is shaped to express a natural object such as a landscape or an animal, irregularities consistent with details of the natural object, such as animal fur or leaves on trees in the landscape, may be formed on the three-dimensional object.

The three-dimensional object may be colored by having its surface (upper surface) printed as in the conventional two-dimensional (2D) printing. This may broaden a color reproducible range as compared to the conventional coloring methods using 3D printers.

The operations described so far may be effectuated by a simpler shaping technique than the conventional 3D printers. For example, these operations may be carried out by controlling an ink jet printer in a predetermined manner. The inventors of this application confirmed through tests that three-dimensional objects were obtainable more readily and easily by these operations than by the conventional 3D printers. To address the conventional issues, this invention provides for the following technical features.

[Configuration 1] Provided is a three-dimensional object shaping device configured to shape a three-dimensional object that is colored. The three-dimensional object shaping device includes: a three-dimensional shape forming head that discharges droplets of a curable liquid curable under predetermined conditions to shape the three-dimensional object; a curing unit that cures the curable liquid discharged from the three-dimensional shape forming head; a coloring head that discharges droplets of a coloring ink based on a print image to be printed on a surface of the three-dimensional object to color the three-dimensional object; and a controller that controls the operations of the three-dimensional shape forming head, the curing unit, and the coloring head. The controller prompts the three-dimensional shape forming head and the curing unit to carry out: a layered three-dimensional object forming operation of forming and layering a plurality of layers that covers a preset region by curing the curable liquid to form a layered three-dimensional object constituting a part of the three-dimensional object, the layered three-dimensional object including steps generated by layering at least a part of the plurality of layers made of the curable liquid; and a step coating layer forming operation of forming a layer made of the curable liquid so as to overlap the steps in the layered three-dimensional object. The three-dimensional object is colored by the coloring head after the step coating layer forming operation performed is over.

The three-dimensional object shaping device thus characterized may form a three-dimensional object having an adequate thickness by layering the plural layers in the layered three-dimensional object forming operation. Then, the three-dimensional object shaping device proceeds to the step coating layer forming operation to prevent the unfavorable steps generated in the process of layering the plural layers from grabbing attention. As a result, the three-dimensional object presenting a natural appearance may be suitably obtained by a simplified shaping technique.

The curable liquid may be an ink curable under predetermined conditions. The three-dimensional shape forming head may discharge droplets of the curable liquid by inkjet printing. The three-dimensional shape forming head may discharge the droplets of the curable liquid by performing main scans (scan operation). The main scan may refer to an operation in which the head discharges the droplets while moving in a preset main scanning direction.

For each one of the main scans performed by the three-dimensional shape forming head, the curing unit cures the curable liquid discharged then. In this instance, the curing unit may cure the curable liquid while moving with the three-dimensional shape forming head in the main scanning direction. The curable liquid may be cured by the time when the three-dimensional shape forming head that finished a current one of the main scans performs a next one of the main scans. The curing unit may cure the curable liquid every time when plural main scans are performed by the three-dimensional shape forming head.

The layered three-dimensional object forming operation may layer a plurality of layers formed by solid printing. The solid printing described herein may mean that a certain region is painted out at a preset concentration (printing concentration). The layered three-dimensional object forming operation may successively form and stack layers each specified by one of a plurality of pieces of data (pieces of layer data) prepared beforehand in accordance with the shape of a three-dimensional object to be shaped. In this instance, the pieces of layer data may be data representing the cross-sectional shape of a three-dimensional object to be shaped.

The step coating layer forming operation may be more specifically an irregularities forming operation described later. The irregularities forming operation may be an operation of printing a gray-scaled image. This may prevent the unfavorable steps from grabbing attention. As a result, a three-dimensional object presenting a natural appearance may be appropriately formed.

The irregularities forming operation is a non-limiting example of the step coating layer forming operation. For example, the step coating layer forming operation may form an overcoat layer that overlays at least the steps of the layered three-dimensional object. In this instance, the overcoat layer may have a thickness equal to the thickness of one of the curable liquid layers constituting the layered three-dimensional object. The overcoat layer may have a greater thickness than the one-layer thickness. The steps covered with the overcoat layer and their vicinity in the layered three-dimensional object, as if they were snow-capped roof tiles, may prevent contours of the steps from standing out. As a result, a three-dimensional object presenting a natural appearance may be appropriately shaped.

[Configuration 2] The layered three-dimensional object forming operation forms the layered three-dimensional object including steps corresponding to the print image, thereby allowing a target object to be favorably expressed.

[Configuration 3] The curable liquid is an ultraviolet curing-type ink. The curing unit is an ultraviolet irradiator. The three-dimensional shape forming head and the coloring head are ink jet heads that discharge ink droplets by inkjet printing. In the layered three-dimensional object forming operation and the step coating layer forming operation, the three-dimensional shape forming head performs main scans of discharging the ink droplets while moving in a preset main scanning direction to discharge the ink droplets to positions specified by the controller. The device thus configured may appropriately carry out the layered three-dimensional object forming operation and the step coating layer forming operation. As a result, a three-dimensional object presenting a natural appearance may be successfully shaped. In this instance, the coloring ink discharged from the coloring head may preferably be an ultraviolet curing-type ink as well.

[Configuration 4] The plurality of layers constituting the layered three-dimensional object are layered on one another in a manner that upper ones of the layers each overlap a lower layer within at least a partial region of the lower layer. The three-dimensional object thus obtained may be an object undergoing no overhang. The overhang may refer to a structure in which an upper-side portion(s) projects more outward than a lower-side portion(s) in at least a part of the three-dimensional object. In this instance, the upper-side portion of the three-dimensional object means a portion on the side of the layers formed later than the preceding layers.

When, for example, an overhang-structured three-dimensional object is desirably formed, a support material may be necessary to support the relevant portion protruding outward. This may complicate the process of shaping the three-dimensional object, in which case the conventional 3D printer may be preferred over the simplified shaping technique.

By preventing such an overhang, the three-dimensional object presenting a natural appearance may be successfully shaped and colored by the simplified shaping technique described so far. According to this configuration, therefore, a three-dimensional object undergoing no overhang may be appropriately formed.

[Configuration 5] The three-dimensional shape forming head is an ink jet head that discharges droplets of at least one of a white ink and a clear ink. These inks may assist in forming the three-dimensional object in a suitable shape.

[Configuration 6] The controller prompts the three-dimensional shape forming head and the curing unit to carry out, as the step coating layer forming operation, an irregularities forming operation of discharging the droplets of the curable liquid on the layered three-dimensional object based on the print image to form irregularities corresponding to the print image on the layered three-dimensional object, and the coloring head colors the three-dimensional object after the irregularities are formed by the irregularities forming operation.

The irregularities forming operation may allow the irregularities to be formed on the layered three-dimensional object correspondingly to details in the shape of a target object to be expressed by the three-dimensional object. According to this configuration, therefore, a three-dimensional object presenting a natural appearance may be more appropriately formed.

Discharging the curable liquid droplets based on the print image in the irregularities forming operation may be rephrased as performing the printing operation based on the print image. Performing the printing operation based on the print image may be more specifically printing the print image or an image obtained by subjecting the print image to a predetermined image process. The coloring head may print the print image in positional alignment with the irregularities formed in the irregularities forming operation. According to this configuration, therefore, a three-dimensional object presenting a more natural appearance may be more appropriately formed.

[Configuration 7] In the irregularities forming operation, the three-dimensional shape forming head forms an irregularities formation layer by discharging the droplets of the curable liquid based on the print image, and the three-dimensional shape forming head forms and layers a plurality of the irregularities formation layers to form the irregularities corresponding to the print image on the layered three-dimensional object. The layers formed in the irregularities forming operation may accordingly have adequate thicknesses. Then, irregularities consistent with details in the shape of a target object to be expressed by the three-dimensional object may be more appropriately formed.

In the case a target object to be expressed by the three-dimensional object is a real object or a real person, the target object′ shape is a real shape of the object or the person. In the case a target object to be expressed by the three-dimensional object is an imaginary object or an imaginary character (for example, an animation character), the target object′ shape may be an imaginary shape of the object or the character.

[Configuration 8] In the irregularities forming operation, the three-dimensional shape forming head carries out an operation of printing a gray-scaled image based on the print image using the curable liquid to form the irregularities corresponding to the print image on the layered three-dimensional object. Then, irregularities consistent with details in the shape of a target object to be expressed by the three-dimensional object may be more appropriately formed.

[Configuration 9] The gray-scaled image is an image obtained by subjecting the print image to gray scaling, and to tone reversal for at least a partial region of the print image.

When, for example, the gray-scaled image is printed in the irregularities forming operation, the irregularities may be formed correspondingly to degrees of shading (tone values) in the image. Then, of the irregularities thereby formed, dark parts in the image are formed as protrusions, while bright parts in the image are formed as recesses. Taking the print image processed by gray scaling alone for instance, any shaded parts in the print image become dark parts in the gray-scaled print image. In the case the gray-scaled image obtained by subjecting the print image to gray scaling alone is used in the irregularities forming operation to form the irregularities, the shaded parts in the print image are formed as protrusions.

In natural objects including landscapes and animals, however, recessed parts are mostly shaded parts. Any three-dimensional object in which the shaded parts are formed as protrusions may be likely to result in an unnatural appearance.

By subjecting the print image to tone reversal in addition to gray scaling, any shaded parts in the print image become bright parts in the gray-scaled print image. In this instance, the irregularities are formed in the print image in the irregularities forming operation so that the shaded parts are formed as recesses. According to this configuration, therefore, a three-dimensional object presenting a natural appearance may be more appropriately formed.

[Configuration 10] The controller prompts the three-dimensional shape forming head and the curing unit to further carry out an irregularities covering operation of forming a layer by curing the curable liquid in a region that covers the irregularities formed in the irregularities forming operation, and the coloring head colors the three-dimensional object after the irregularities covering operation is over.

The steps resulting from the plural layers formed in the layered three-dimensional object forming operation may be rendered less noticeable by forming fine irregularities in the irregularities forming operation. However, such fine irregularities are formed in a region to be colored by the coloring head. In the case the object is desirably colored at a high resolution, such fine irregularities may become a drawback in broadening the color reproducible range of the coloring ink.

In contrast, this configuration including the irregularities covering operation may effectively reduce such a negative impact from the irregularities formed in the irregularities forming operation. This may assist in adequately broadening the color reproducible range of the coloring ink.

[Configuration 11] Provided is a three-dimensional object shaping method of shaping a three-dimensional object that is colored. The three-dimensional object shaping method includes uses of: a three-dimensional shape forming head that discharges droplets of a curable liquid curable under predetermined conditions to shape the three-dimensional object; a curing unit that cures the curable liquid discharged from the three-dimensional shape forming head; and a coloring head that discharges droplets of a coloring ink based on a print image to be printed on a surface of the three-dimensional object to color the three-dimensional object. The method further includes prompting the three-dimensional shape forming head and the curing unit to carry out: a layered three-dimensional object forming operation of forming and layering a plurality of layers that covers a preset region by curing the curable liquid to form a layered three-dimensional object constituting a part of the three-dimensional object, the layered three-dimensional object including steps generated by layering at least a part of the plurality of layers made of the curable liquid; and a step coating layer forming operation of forming a layer made of the curable liquid so as to overlap the steps in the layered three-dimensional object. The three-dimensional object is colored by the coloring head after the step coating layer forming operation performed is over. The method according to this configuration may achieve effects similar to the effects of the Configuration 1.

### Effect of the Invention

This invention may successfully shape a three-dimensional object by a simplified shaping technique.

### BRIEF DESCRIPTION OF DRAWINGS

FIGS. 1A and 1B are drawings of a three-dimensional object shaping device 10 according to an embodiment of this invention. FIG. 1A is a drawing of exemplified structural elements of the three-dimensional object shaping device 10. FIG. 1B is a detailed drawing of a head unit 12.

FIGS. 2A-2D illustrate exemplified shaping and coloring operations for a three-dimensional object 50 according to the embodiment. FIG. 2A illustrates an exemplified layered three-dimensional object forming operation. FIG. 2B illustrates an exemplified irregularities forming operation. FIG. 2C illustrates an exemplified irregularities covering operation. FIG. 2D illustrates an exemplified coloring operation.

FIG. 3 is a drawing of an exemplified print image 402 printed in the coloring operation.

FIG. 4 is a drawing of an exemplified image printed in the layered three-dimensional object forming operation.

FIGS. 5A and 5B are drawings of another exemplified image printed in the layered three-dimensional object forming operation. FIGS. 5A and 5B are drawings of pieces of layer data, each for one layer.

FIGS. 6A-6D are drawings of exemplified images printed in the layered three-dimensional object forming operation. FIGS. 6A-6D are drawings of pieces of layer data, each for one layer.

FIG. 7 is a drawing of a gray-scaled image 406 printed in the irregularities forming operation.

### DESCRIPTION OF EMBODIMENTS

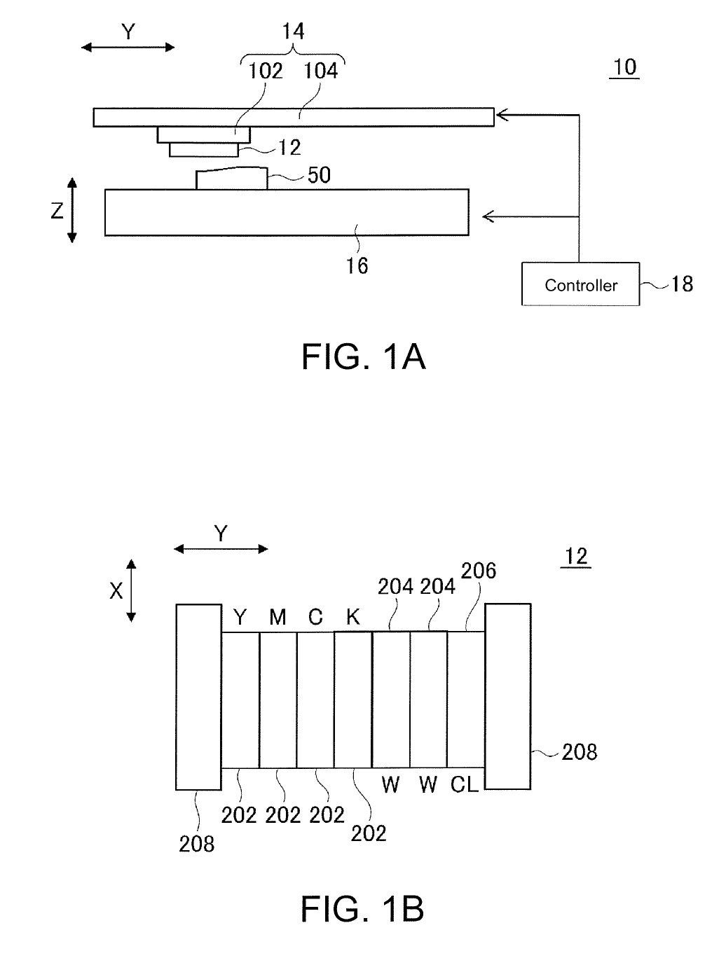

Hereinafter, embodiments of this invention are described referring to the accompanying drawings. FIGS. 1A and 1B are drawings of a three-dimensional object shaping device 10 according to an embodiment of this invention. FIG. 1A is a drawing of exemplified structural elements of the three-dimensional object shaping device 10.

Except for the features hereinafter described, the three-dimensional object shaping device 10 may be identical or similar to the conventional three-dimensional object shaping devices. An example of the three-dimensional object shaping device 10 may be an inkjet printer using ultraviolet curing-type inks. In this instance, the three-dimensional object shaping device 10 may be identical or similar to the conventional inkjet printers except for the operation controls for the respective structural elements.

In this embodiment, the three-dimensional object shaping device 10 is configured to shape a three-dimensional object 50 using ultraviolet curing-type inks. The device includes a head unit 12, a scan driver 14, a table 16, and a controller 18. The head unit 12 discharges droplets of the ultraviolet curing-type inks to shape and color the three-dimensional object 50. In this embodiment, the head unit 12 has a plurality of ink jet heads and ultraviolet light sources. The head unit 12 will be described later in further detail.

The scan driver 14 prompts the head unit 12 to perform main scans and sub scans. Prompting the head unit 12 to perform main scans and sub scans may be more specifically prompting the ink jet heads of the head unit 12 to perform main scans and sub scans. Prompting the ink jet heads to perform main scans may be more specifically prompting the ink jet heads to discharge the ink droplets while moving in a preset main scanning direction (for example, Y direction in the drawing). Prompting the ink jet heads to perform sub scans is more specifically prompting the ink jet heads to move relative to the table 16 in, for example, a sub scanning direction (X direction) orthogonal to the main scanning direction.

In FIG. 1A, the sub scanning direction (X direction) is a direction orthogonal to the illustrated Y and Z directions. In the three-dimensional object shaping device 10 according to this embodiment, the sub scans are performed in the case they are necessary depending on the length of the three-dimensional object 50 to be shaped in the sub scanning direction.

In this embodiment, the scan driver 14 includes a carriage 102 and a guide rail 104. The carriage 102 holds the head unit 12 toward the three-dimensional object 50 to be shaped. Holding the head unit 12 toward the three-dimensional object 50 means that a direction in which the ink droplets are discharged from the head unit 12 coincides with a direction toward the table 16 on which the three-dimensional object 50 is to be formed. The guide rail 104 guides the movement of the carriage 102 in the main scanning direction. During the main scans, the scan driver 14 drives the carriage 102 to move along the guide rail 104, thereby moving the head unit 12 in the Y direction. During the sub scans, the scan driver 14 drives the guide rail 104 to move in the X direction, thereby moving the head unit 12 in the X direction. The three-dimensional object shaping device 10 may be optionally structured to move the table 16 during the sub scans toward the head unit 12 fixed at a position in the sub scanning direction.

The table 16 is a platform on which the three-dimensional object 50 is to be formed. In this embodiment, the table 16 is structured to move its upper surface upward and downward in a predetermined direction (Z direction in the drawing). The up-down direction is a direction in which the head unit 12 and the table 16 facing each other are connectable. Accordingly, a distance between the head unit 12 and the three-dimensional object 50 may be suitably adjusted as the shaping of the three-dimensional object 50 advances.

The controller 18 may be a CPU of the three-dimensional object shaping device 10. The controller 18 controls the operations of the structural elements in the three-dimensional object shaping device 10 as prompted by instructions from a host PC. The three-dimensional object shaping device 10 thus configured shapes and colors the three-dimensional object 50. The operations of shaping and coloring the three-dimensional object 50 will be described later in further detail.

Next, specific features of the head unit 12 are hereinafter described. FIG. 1B is a detailed drawing of a head unit 12. In this embodiment, the head unit 12 includes a plurality of coloring heads 202, a plurality of white ink heads 204, a transparent ink head 206, and a plurality of ultraviolet light sources 208.

The coloring heads 202 are ink jet heads for coloring the three-dimensional object 50. These heads discharge droplets of coloring inks based on a print image to be printed on the surface of the three-dimensional object 50 to color the three-dimensional object 50. Discharging the coloring ink droplets based on the print image may be rephrased as printing the print image on the surface of the three-dimensional object 50. The print image may be a color image. In this embodiment, the coloring heads 202 respectively discharge droplets of ultraviolet curing-type inks in Y, M, C, and K process colors.

The coloring heads 202 may be selected from suitable ones of the conventional ink jet heads. Though not illustrated in the drawing, the coloring heads 202 each have an array of nozzles aligned in the sub scanning direction (X direction). The coloring heads 202 are arranged next to one another in the main scanning direction in positional alignment with one another in the sub scanning direction.

The white ink heads 204 and the transparent ink head 206 are examples of the three-dimensional shape forming head. The three-dimensional shape forming head may be an ink jet head that discharges droplets of, for example, an ultraviolet curing-type ink to shape a three-dimensional object. The white ink heads 204 discharge droplets of a white (W) ultraviolet curing-type ink. The transparent ink head 206 discharges droplets of a clear (CL) ultraviolet curing-type ink. The clear ink refers to a colorless, transparent ink. The clear ink may refer to an ink containing no colorant such as pigment. The clear ink may be selected from clear inks usable in the conventional ink jet printers.

The white ink heads 204 and the transparent ink head 206 may be selected from suitable ones of the conventional ink jet heads. Though not illustrated in the drawing, the white ink heads 204 and the transparent ink head 206 each have an array of nozzles aligned in the sub scanning direction. The white ink heads 204 and the transparent ink head 206 are arranged next to one another in the main scanning direction in positional alignment with the coloring heads 202 in the sub scanning direction.

The ultraviolet light sources 208 emit ultraviolet light to cure the ultraviolet curing-type inks. Suitable examples of the ultraviolet light sources 208 may include UVLED-equipped light sources. In this embodiment, the ultraviolet light sources 208 are respectively disposed on one end side and the other end side in the main scanning direction of the arrangement of the coloring heads 202, white ink heads 204, and transparent ink heads 206. In each one of the main scans, the ultraviolet light sources 208 move with the coloring heads 202, white ink heads 204, and transparent ink head 206. Then, the ultraviolet light sources 208, in each one of the main scans by the head unit 12, cures the ultraviolet curing-type inks discharged then.

The coloring heads 202, white ink heads 204, and transparent ink heads 206 discharge the ultraviolet curing-type inks, as prompted by the controller 18. The ultraviolet light sources 208 cure the ultraviolet curing-type inks discharged. The three-dimensional object shaping device 10 accordingly shapes and colors the three-dimensional object 50 as described below in further detail.

In a modified embodiment of the three-dimensional object shaping device 10, the head unit 12 may be configured in a manner different to the example of FIG. 1B. In the illustration of FIG. 1B, all of the ink jet heads (coloring heads 202, white ink heads 204, and transparent ink head 206) are arranged next to one another in the main scanning direction in positional alignment with one another in the sub scanning direction. Instead, one or some of the ink jet heads in the head unit 12 may be displaced from the other ink jet heads in the sub scanning direction. For example, the white ink heads 204 and the transparent ink head 206 may be positioned with a displacement from the coloring heads 202 in the sub scanning direction. Optionally, the head unit 12 may have a plurality of transparent ink heads 206, and/or may have just one white ink head 204.

At least one or some of the coloring ink jet heads in the head unit 12 may be usable as both of the coloring head and the three-dimensional shape forming head. At least one or some of the C, M, Y, and K coloring heads 202 may be usable as the three-dimensional shape forming head. At least one or some of the three-dimensional shape forming heads (for example, white ink head(s) 204) may be usable as the coloring head.

The coloring heads 202, white ink heads 204, and transparent ink head 206 may be ink jet heads each having a plurality of ink jet heads combined. The coloring heads 202, white ink heads 204, and transparent ink head 206 may be staggered heads each having a plurality of ink jet heads disposed in staggered arrangement.

In this embodiment, the ultraviolet curing-type ink is an example of the curable liquid curable under predetermined conditions. The ultraviolet light source 208 is an example of the curing unit that cures the curable liquid. In a modified embodiment of the three-dimensional object shaping device 10, the curable liquid may be any liquid but the ultraviolet curing-type ink. In that case, the ultraviolet light sources 208 may be replaced with a curing device suitable for any curable liquid used instead.

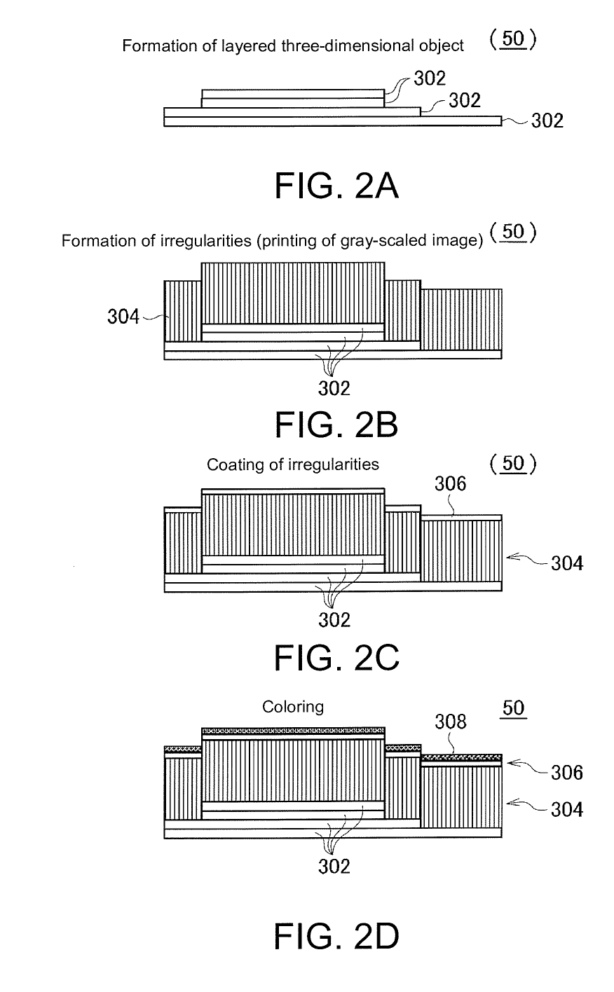

The operations of shaping and coloring the three-dimensional object 50 are hereinafter described in detail. FIGS. 2A-2D illustrate exemplified shaping and coloring operations for the three-dimensional object 50 according to the embodiment. In this embodiment, the three-dimensional object shaping device 10 shapes and colors the three-dimensional object 50 by carrying out a layered three-dimensional object forming operation, an irregularities forming operation, an irregularities covering operation, and a coloring operation. The three-dimensional object shaping device 10 may carry out these operations as instructed by a preinstalled program.

In this embodiment, the three-dimensional object shaping device 10 shapes the three-dimensional object 50 undergoing no overhang. The overhang may refer to a structure in which an upper-side portion(s) projects more outward than a lower-side portion(s) in at least a part of the three-dimensional object. In this instance, the upper-side portion of the three-dimensional object means a portion on the side of the layers formed later than the preceding layers. In this embodiment, the upper side of the three-dimensional object is specifically a vertically upper side.

In this embodiment, the irregularities forming operation is an example of the step coating layer forming operation. The step coating layer forming operation forms a layer made of the ultraviolet curing-type inks so as to overlap the steps formed on a layered three-dimensional object by the layered three-dimensional object forming operation. In a modified embodiment of the three-dimensional object shaping device 10, the step coating layer forming operation may form an overcoat layer.

FIG. 2A illustrates an exemplified layered three-dimensional object forming operation. In this embodiment, the layered three-dimensional object forming operation may successively form and layer solid print ink layers 302 based on a plurality of pieces of data (pieces of layer data) prepared beforehand in accordance with the shape of the three-dimensional object 50 to be shaped. In the layered three-dimensional object forming operation, the three-dimensional object shaping device 10 forms rough irregularities representing the outline of the three-dimensional object 50. The pieces of layer data may be data representing the cross-sectional shape of a three-dimensional object to be shaped.

In the layered three-dimensional object forming operation according to this embodiment, the three-dimensional object shaping device 10 forms and layers a plurality of solid print ink layers 302 that each painted out a preset region using the white ink heads 204 and the transparent ink head 206. The solid print ink layer 302 is a layer formed by curing the ultraviolet curing-type ink that covers a preset region. As a result, a layered three-dimensional object constituting a part of the three-dimensional object 50 is obtained that includes layers formed by curing the ultraviolet curing-type ink and layered on one another.

In this embodiment, the three-dimensional object shaping device 10 carries out the layered three-dimensional object forming operation using two of the white ink heads 204 and the transparent ink head 206 in the head unit 12. The two white ink heads 204 and the transparent ink head 206 perform main scans as prompted by instructions from the controller 18 to discharge the ink droplets to positions specified by the controller 18. Each one of the main scans forms one solid print ink layer 302.

In each one of the main scans, the controller 18 prompts the two white ink heads 204 and the transparent ink head 206 to discharge the ink droplets at the concentration of 100% to a region where the solid print ink layer 302 should be formed. The concentration of 100% is the highest concentration preset in the three-dimensional object shaping device 10. This highest concentration may be more specifically the highest concentration set for solid printing by one main scan using one nozzle array of one ink jet head. When the solid print ink layer 302 is formed by three ink jet heads as described in this embodiment, one solid print ink layer 302 is formed at the concentration of 300% in total.

In the layered three-dimensional object forming operation according to this embodiment, the three-dimensional object shaping device 10 forms the solid print ink layers 302 while preventing overhang. Forming the solid print ink layers 302 while preventing overhang means layering the solid print ink layers 302 constituting the layered three-dimensional object in a manner that upper ones of the solid print ink layers 302 each overlap a lower layer within at least a partial region of the lower layer.

In this embodiment, the three-dimensional object shaping device 10 carries out the irregularities forming operation subsequent to the layered three-dimensional object forming operation. FIG. 2B illustrates an exemplified irregularities forming operation. In this embodiment, the irregularities forming operation forms fine irregularities consistent with details on the print image used to color the three-dimensional object 50.

In the irregularities forming operation according to this embodiment, the three-dimensional object shaping device 10 prints a gray-scaled image prepared by using the white ink heads 204 and the transparent ink head 206 to form a gray-scaled print layer 304 on the solid print ink layer 302.

The gray-scaled image used in this embodiment is obtained from the print image. The gray-scaled image obtained from the print image may be a gray-scaled image obtained by subjecting the print image printed in colors to image processes. As the gray-scaled image may be suitably used an image obtained by subjecting the print image to gray scaling, and to tone reversal for at least a partial region of the print image. Specific examples of the print image and the gray-scaled image will be described later by way of a working example.

When the gray-scaled image thus obtained is used, the three-dimensional object shaping device 10 discharges in the irregularities forming operation the droplets of the ultraviolet curing-type inks, based on the print image, on the layered three-dimensional object formed of the solid print ink layers 302. The three-dimensional object shaping device 10 accordingly forms fine irregularities on the layered three-dimensional object correspondingly to the print image.

In the irregularities forming operation, the concentration of the ink discharged in each main scan may be less than or equal to 30%, preferably less than or equal to 25%, or more preferably less than or equal to 22%. Preferably, the gray-scaled print layer 304 may be formed by printing the gray-scaled image more than once.

Specifically, the irregularities forming operation according to this embodiment may form the gray-scaled print layer 304 by layering a plurality of ink layers. Specifically, the three-dimensional object shaping device 10 forms one ink layer (hereinafter, irregularities formation layer) at each time when one gray-scaled image is printed. By printing the gray-scaled images more than once, the gray-scaled print layer 304 is formed that includes the irregularities formation layers plurally layered on one another. This may adequately increase the gray-scaled print layer 304 in thickness, allowing the irregularities to be more distinctly formed correspondingly to the print image. Then, irregularities consistent with details in the shape of a target object to be expressed by the three-dimensional object 50 may be more appropriately formed.

A generalized definition of the irregularities forming operation may be an operation of discharging the ultraviolet curing-type inks based on the print image. Discharging the ultraviolet curing-type inks based on the print image means performing the printing operation based on the print image. Performing the printing operation based on the print image may be more specifically printing the print image or an image obtained by subjecting the print image to predetermined image processes.

In this embodiment, the three-dimensional object shaping device 10 carries out the irregularities covering operation subsequent to the irregularities forming operation. FIG. 2C illustrates an exemplified irregularities covering operation. In this embodiment, the irregularities covering operation is an operation of forming a coating layer 306 as an ink layer that covers the irregularities formed in the irregularities forming operation.

In the irregularities covering operation according to this embodiment, the three-dimensional object shaping device 10 forms the coating layer 306 by solid printing at a predetermined concentration of at least a part of a region of the three-dimensional object 50 to be colored later using at least any one of the white ink heads 204 and the transparent ink head 206. Preferably, the three-dimensional object shaping device 10 forms the coating layer 306 in the whole of the region of the three-dimensional object 50 to be colored layer. Depending on a demanded precision and/or application of the three-dimensional object 50, the coating layer 306 may be optionally formed in a part of the region to be colored later.

Specifically, the controller 18, in the irregularities covering operation, prompts the ultraviolet light sources 208 and at least any one of the white ink heads 204 and the transparent ink head 206 to form the coating layer 306 by curing the ultraviolet curing-type ink in a region that covers the irregularities formed in the irregularities forming operation. The coating layer 306 may be formed by, for example, solid printing at a concentration greater than or equal to 75% using the white or clear ultraviolet curing-type ink.

In the irregularities covering operation, the fine irregularities formed in the irregularities forming operation are smoothed by forming thereon the coating layer 306 to prevent the color reproducible range of the coloring ink from being narrowed by the presence of such fine irregularities. Therefore, the ultraviolet curing-type ink is preferably cured glossy in the irregularities covering operation. The glossy cure of the ultraviolet curing-type ink means curing the ink after ink dots formed by the ink droplets that landed at a target position are adequately spread. The glossy cure of the ultraviolet curing-type ink may more specifically mean curing the ultraviolet curing-type ink later, instead of immediately irradiating the ink during a droplet-discharged main scan with ultraviolet light from the ultraviolet light sources 208. In this instance, regions of the three-dimensional object 50 may be irradiated with ultraviolet light by having the ultraviolet light sources 208 perform scans after the main scans for the regions are over.

In this embodiment, the three-dimensional object shaping device 10 carries out the coloring operation subsequent to the irregularities covering operation. FIG. 2D illustrates an exemplified coloring operation. In this embodiment, the coloring operation prints the print image on the surface of the three-dimensional object 50 using the coloring heads 202 to form a colored layer 308 on the three-dimensional object 50. In this instance, the surface of the three-dimensional object 50 may be a region where the coating layer 306 is formed in the irregularities covering operation.

In the coloring operation, the three-dimensional object shaping device 10 may carry out the printing operation for the three-dimensional object 50 in the same manner as or in a similar manner to the conventional ink jet printers configured to print an object on a three-dimensional medium. The three-dimensional object shaping device 10 may print the print image by leveraging multipass printing. The multipass printing performs plural main scans at each of positions in a print target region of the three-dimensional object 50. The multipass printing may allow the print image to be printed with a higher accuracy.

In the coloring operation, the coloring heads 202 print the print image in positional alignment with the irregularities formed in the irregularities forming operation. Printing the print image in positional alignment with the irregularities formed in the irregularities forming operation may be rephrased as printing the print image so as to overlap the gray-scaled image printed in the irregularities forming operation. Printing the print image so as to overlap the gray-scaled image is to positionally align and print these images so as to overlap each other. This may allow the three-dimensional object to be more naturally colored.

After these operations are over, the layered three-dimensional object forming operation forms and layers the solid print ink layers 302 to express an adequate thickness of the three-dimensional object 50. By the irregularities forming operation subsequently carried out, the irregularities may be formed correspondingly to details in the shape of a target object to be expressed by the three-dimensional object 50. This operation may prevent the steps generated by layering the solid print ink layers 302 from standing out. In this embodiment, the three-dimensional object 50 presenting a natural appearance may be successfully shaped.

The irregularities covering operation interposed between the irregularities forming operation and the coloring operation may reduce any negative impact from the irregularities formed in the irregularities forming operation. This may assist in adequately broadening the color reproducible range of the coloring inks used in the coloring operation. In this embodiment, the colored three-dimensional object 50 may be successfully shaped.

This embodiment uses the white ink heads 204 as the three-dimensional shape forming head. Examples of the white ink used in the white ink heads may include inks colored with pigments made of inorganic substances (for example, titanium oxide). By using any one of such inks, the three-dimensional object 50 shaped may be barely thermally shrinkable. This may stabilize the shape of the three-dimensional object 50.

The gray-scaled image used in the irregularities forming operation is hereinafter described in further detail. When the gray-scaled image is printed in the irregularities forming operation, the irregularities may be formed correspondingly to degrees of shading (tone values) in the image. Then, of the irregularities formed, dark parts in the image are formed as protrusions, while bright parts in the image are formed as recesses. Taking the print image processed by gray scaling alone for instance, any shaded parts in the print image become dark parts in the gray-scaled print image. When the gray-scaled image obtained by subjecting the print image to gray scaling alone is used in the irregularities forming operation to form the irregularities, the shaded parts in the print image are formed as protrusions.

In natural objects including landscapes and animals, however, recessed parts may be often shaded parts. Any three-dimensional object in which the shaded parts are formed as protrusions may be likely to result in an unnatural appearance.

As described earlier, an image suitably used as the gray-scaled image in the irregularities forming operation may be obtained by subjecting the print image to gray scaling, and to tone reversal for at least a partial region of the print image. In the gray-scaled image obtained by thus processing the print image, any shaded parts in the print image become bright parts in the gray-scaled image. By using the gray-scaled image in the irregularities forming operation, fine irregularities may be formed that allow the shaded parts in the print image to be formed as recesses. As a result, the three-dimensional object 50 presenting a more natural appearance may be successfully formed.

As the gray-scaled image for the irregularities forming operation may be suitably used an image obtained by subjecting the print image to gray scaling, and to tone reversal for the whole region of the print image. The process of obtaining the gray-scaled image may be accordingly facilitated. Optionally, a user may select a suitable region depending on a target object to be expressed by the three-dimensional object and subject the print image to tone reversal for only a partial region of the print image. This may assist in forming the three-dimensional object presenting a more natural appearance.

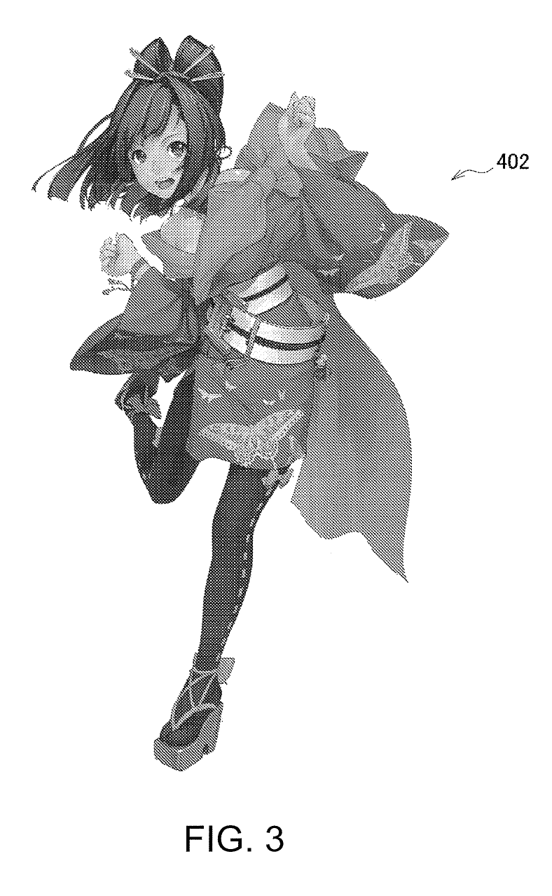

The operations according to this embodiment are hereinafter described in detail by way of a working example of this invention. FIG. 3 to FIG. 7 are drawings of exemplified images printed in different stages of the working example. The working example controls the operation of an inkjet printer that uses ultraviolet curing-type inks so as to function as the three-dimensional object shaping device. For descriptive convenience, the description starts with an exemplified print image printed in the coloring operation.

FIG. 3 is a drawing of an exemplified print image 402 printed in the coloring operation. In this working example, the three-dimensional object shaping device 10 prints the print image using the coloring heads 202 and thereby colors the three-dimensional object 50. The print image 402 used in this working example is a color image. To facilitate the illustration, however, FIG. 3 illustrates a gray-scaled image of the originally colored print image 402.

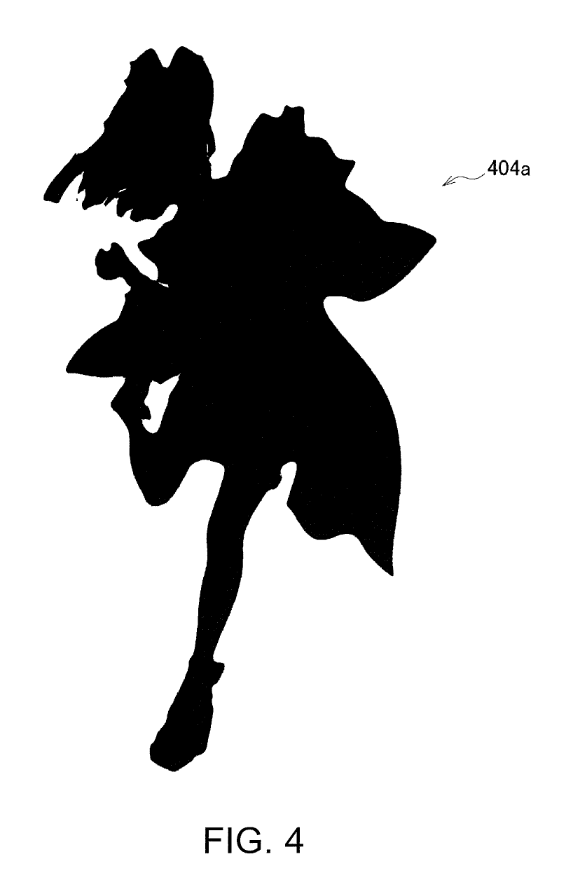

FIG. 4 to FIG. 6D are drawings of exemplified images printed in the layered three-dimensional object forming operation. The images printed in the layered three-dimensional object foil ling operation in this working example refers to pieces of layer data used to form the solid print ink layers 302 (see FIGS. 2A-2D). The layer data is solid print data indicating a region where the solid print ink layers 302 should be formed.

This working example carries out the layered three-dimensional object forming operation using pieces of layer data 404a to 404g illustrated in FIG. 4 to FIG. 6D. The pieces of layer data 404a to 404g each correspond to one solid print ink layer 302. The three-dimensional object shaping device 10 forms and layers the solid print ink layers 302 respectively corresponding to the pieces of layer data 404a to 404g in this order.

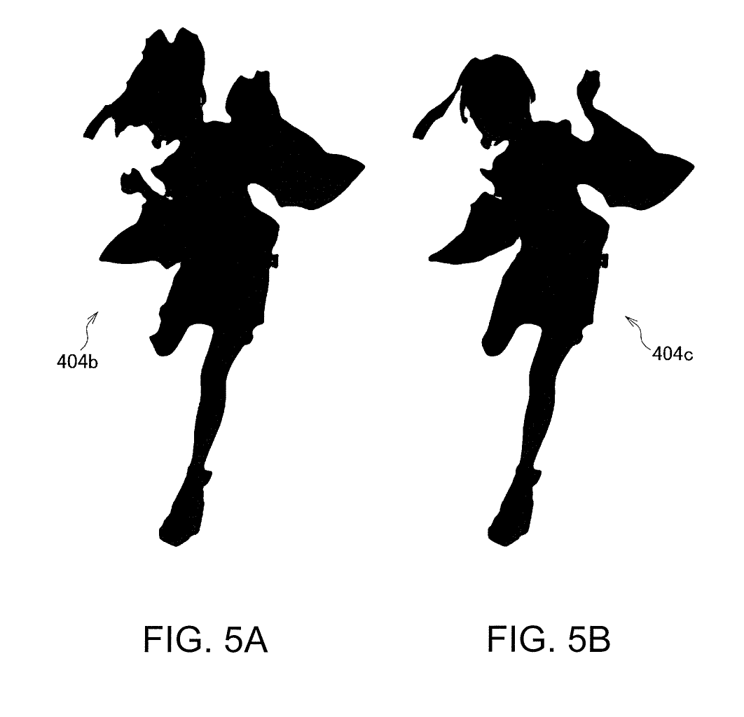

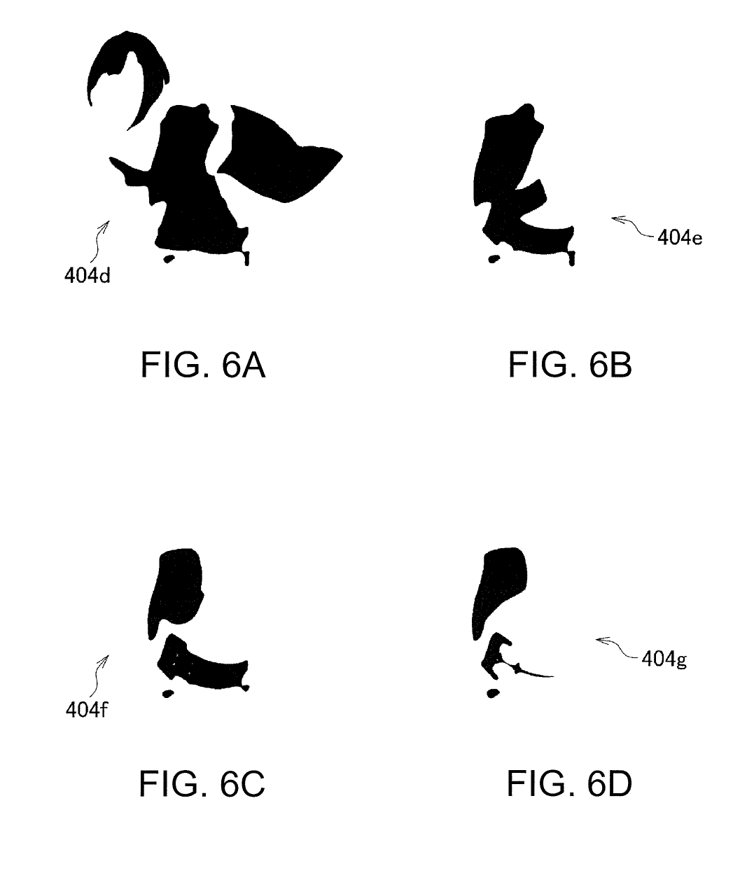

Specifically, in this working example, the three-dimensional object shaping device 10 starts with forming a first one of the solid print ink layers 302 based on the piece of layer data 404a illustrated in FIG. 4. Then, the three-dimensional object shaping device 10 forms a second one of the solid print ink layers 302 based on the piece of layer data 404b illustrated in FIG. 5A on the solid print ink layer 302 formed correspondingly to the piece of layer data 404a. Then, the three-dimensional object shaping device 10 forms a third one of the solid print ink layers 302 based on the piece of layer data 404c illustrated in FIG. 5B on the solid print ink layer 302 formed correspondingly to the piece of layer data 404b. Thereafter, the solid print ink layers 302 are successively formed based on the pieces of layer data 404d to 404g illustrated in FIGS. 6A to 6D and layered on the previously formed solid print ink layers 302.

Of the pieces of layer data used in this working example, the pieces of layer data 404a to 404c are specified for solid printing of the whole or a substantially whole region of the three-dimensional object to be shaped. By forming three solid print ink layers 302 correspondingly to the pieces of layer data 404a to 404c, the ink layers may be formed to a predetermined height. As a result, the whole three-dimensional object has an adequate thickness.

The pieces of layer data 404d to 404g are per-portion data specified to locally form the irregularities in the three-dimensional object. By forming the solid print ink layers 302 respectively corresponding to the pieces of layer data 404d to 404g, protrusions representing parts constituting the three-dimensional object may be formed to a predetermined height in a partial region of the solid print ink layers 302 formed based on the pieces of layer data 404a to 404c.

The pieces of layer data 404a to 404g may be prepared in advance by a user based on the print image 402. The pieces of layer data 404a to 404g may be prepared automatically based on the print image 402 and/or three-dimensional shape data of a target object. A suitable example of the pieces of layer data 404a to 404g may be data processed by an image processing software so as to blur edge parts of the layers. A more natural shape may be accordingly expressed by the solid print ink layers 302.

In this working example, the solid print ink layers 302 are formed by using the white ink heads 204. In the process of forming a three-dimensional object using, for example, an inkjet printer, a white region may be regarded as a region where the ink droplets need not be discharged. For that reason, this working example prepares the pieces of layer data 404a to 404g as data representing regions to be printed in black (K). By controlling the white ink heads 204 and the transparent ink head 206 based on the data representing regions to be printed in black, the solid print ink layers 302 may be appropriately formed. Optionally, the pieces of layer data 404a to 404g may be prepared as data representing regions to be printed in any color but black.

In this working example, the solid print ink layers 302 are formed by solid printing of the regions represented by the pieces of layer data 404a to 404g as described earlier referring to FIGS. 1A-1B and 2A-2D. The solid print ink layers 302 are each formed in a single printing operation by three ink jet heads (two white ink heads 204 and transparent ink head 206) based on each piece of layer data (each of the pieces of layer data 404a to 404g). In this working example, therefore, the concentration of one solid print ink layer 302 results in 300%. The number of printing operations is the total number of repeated sub scans involving main scans for each region of the three-dimensional object 50. The concentration of one solid print ink layer 302 equals to the product of the number of nozzle arrays, printing concentration, and the number of printing operations (number of nozzle arrays×printing concentration×number of printing operations). The number of nozzle arrays equals to the product of the number of ink jet heads used to form the solid print ink layer 302 and the number of nozzle arrays of one ink jet head. The printing concentration means a solid print concentration in one nozzle array. The printing concentration may be rephrased as an ink amount discharged in a sub scan involving a main scan (amount of ink discharged).

The solid print ink layers 302 may each include a plurality of layered ink layers. In that case, the plural ink layers may preferably be formed and layered by repeatedly printing the whole surface of a region where the solid print ink layer 302 should be formed. When the whole surface is repeatedly printed at the concentration of 100%, amounting in total to the concentration of 300%, to form each solid print ink layer 302, the whole surface is printed at the concentration of 100% to form a first one of the ink layers. Then, a second one of the ink layers is formed on the first layer by printing the whole surface at the concentration of 100%, and a third one of the ink layers is further formed on the second layer by printing the whole surface at the concentration of 100%. As a result, the solid print ink layers 302 may be each formed at a high concentration.

To form each solid print ink layer 302 at the concentration of 300%, the main scans may be performed repeatedly three times for each band; a target region for one main scan. This, however, may increase the risk of banding and/or may involve the risk of ink splashes at the time of printing for a next band. By repeating the whole surface printing as described, on the other hand, the high-concentration solid print ink layers 302 may be safely formed without such risks.

The concentration of one solid print ink layer 302 may not necessarily be limited to 300%. The concentration of one solid print ink layer 302 may be elevated by increasing the number of nozzle arrays used and/or increasing the number of printing operations. The concentration of one solid print ink layer 302, however, may preferably be at most 1,500%, because the object finally shaped may have an unnatural appearance if the solid print ink layer 302 corresponding to the same piece of layer data exceed 1,500% in concentration and becomes too thick.

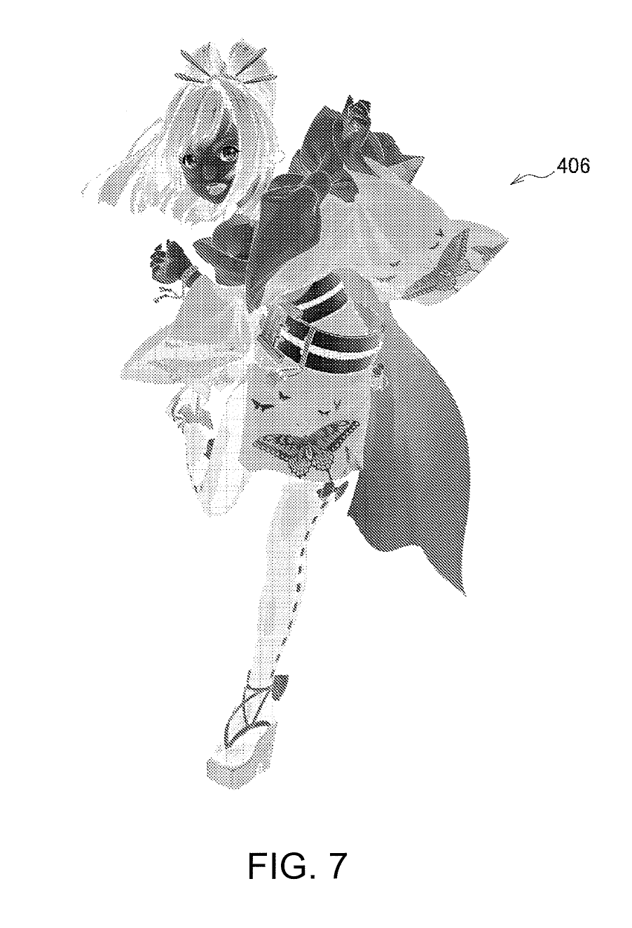

FIG. 7 is a drawing of a gray-scaled image 406 printed in the irregularities forming operation. In this working example, the gray-scaled image 406 is prepared in advance by subjecting the print image 402 to gray scaling and tone reversal. In the gray-scaled print layer 304 obtained by printing the gray-scaled image 406 further subjected to tone reversal, the number of ink layers may be decreased for deep-colored parts but increased for pale-colored parts of the original print image 402. Further, the gray-scaled print layer 304 may be formed so that any shaded parts on the print image 402 are formed as recesses.

This embodiment shapes a three-dimensional object representing a figure. The figure's irises may normally appear more natural when formed as protrusions than as recesses. In this working example, the image obtained by subjecting the print image 402 to gray scaling and tone reversal is further subjected to tone reversal in its eye parts to obtain the gray-scaled image 406. The gray-scaled image 406 may be rephrased as an image obtained by subjecting the print image 402 to gray scaling, and to tone reversal for any region but eye parts of the image.

In this working example, a user processed the print image 402 using an image processing software to obtain the gray-scaled image 406. The user, while checking the gray-scaled image 406 being formed, adjusted the brightness and contrast settings in the image processing software. The gray-scaled image 406 may be obtained automatically through a preinstalled program.

In the irregularities forming operation of this working example, the gray-scaled image 406 is printed to form the gray-scaled print layer 304. Then, fine irregularities may be formed correspondingly to details in the shape of the print image 402. This may render the steps formed by layering the solid print ink layers 302 less noticeable, providing a three-dimensional structure presenting a natural appearance.

In the irregularities forming operation, the gray-scaled image 406 may preferably be printed repeatedly so as to have a plurality of ink layers constitute the gray-scaled print layer 304. Specifically, the gray-scaled image 406 is printed eight times to form the gray-scaled print layer 304 having a thickness equal to a total thickness of eight ink layers each formed in one printing operation.

Unlike the solid print ink layer 302, the thickness of the gray-scaled print layer 304 is not limited to the thickness obtained at the concentration of 1,500%. The thickness of the gray-scaled print layer 304 may preferably be decided depending on fineness and/or demanded precision of irregularities to be formed. When, for example, such a detailed shape as an animal fur is desirably expressed, the number of printing operations to be repeated may preferably be increased to further thicken the gray-scaled print layer 304.

In the irregularities forming operation, the ink amount discharged in one main scan (printing concentration) may preferably be less than or equal to 22%. This may allow fine irregularities to be more appropriately formed. The number of printing operations to be repeated may be increased suitably for a selected printing concentration.

Specifically, the printing operations may be repeated approximately 20 times (approximately 15 to 25 times) to print the gray-scaled image 406. The ink jet heads used in the irregularities forming operation may be one or some of the white ink heads 204 and the transparent ink head 206 (for example, white ink head(s) 204 alone) depending on a selected printing concentration. Similarly to the pieces of layer data 404a to 404g used in the layered three-dimensional object foil ling operation, this working example prepares black (K) printing image data for the gray-scaled image 406.

In this working example, the image processes applied to obtain the gray-scaled image 406 from the print image 402 includes tone reversal of the print image 402 for the whole region except for a part thereof. The whole print image 402 may be desirably subjected to tone reversal for some target objects to be expressed by the three-dimensional object, whereas the tone reversal per se may be skipped for some target objects.

In this embodiment, the irregularities forming operation is followed by the irregularities covering operation. In the irregularities covering operation, as described in connection with FIGS. 2A-2D, the coating layer 306 is printed and formed by discharging the white or clear ink at a high concentration greater than or equal to 75% so as to overlay the fine irregularities formed in the irregularities forming operation.

Though not illustrated in the drawings, data representing images to be printed in the irregularities covering operation may be data for painting out the whole region to be colored based on the print image 402. A specific example of the data may be data for painting out the same region as the piece of layer data 404a corresponding to the undermost solid print ink layer 302 of the three-dimensional object.

In this working example, the irregularities covering operation is followed by the coloring operation. The coloring operation prints the print image 402 on the coating layer 306 using the coloring heads 202. As a result, the three-dimensional object may be shaped and colored as desired.

As described earlier, this working example that carries out the irregularities forming operation using the gray-scaled image 406 may allow the detailed shape of a target object to be naturally expressed. The irregularities forming operation may be particularly useful in expressing natural objects including animals and plants.

In this working example, the three-dimensional object shaping device 10 may be used to shape plainly shaped three-dimensional objects with no intricate part. Specifically, the three-dimensional object shaping device 10 according to this working example may be used to shape, for example, chocolates and keyboards. Unlike the natural objects, it is unnecessary in such objects to express intricate shapes, for example, animal fur. In the case of such objects, the irregularities forming operation may be skipped, and the concentration of each solid print ink layer 302 formed in the layered three-dimensional object forming operation may be greater than 1,500%.

Thus far were described the embodiments of this invention. However, the technical scope of this invention is not necessarily limited to the described embodiments. Those skilled in the art should obviously understand that the embodiments may be subject to various changes and/or improvements. As is clearly understood from the appended claims, it should be understood such changes and/or improvements are included in the technical scope of this invention.

### INDUSTRIAL APPLICABILITY

This invention may be usefully applicable to three-dimensional object shaping devices.

1. A three-dimensional object shaping device configured to shape a three-dimensional object that is colored, the three-dimensional object shaping device comprising:
a three-dimensional shape forming head that discharges droplets of a curable liquid curable under predetermined conditions to shape the three-dimensional object;
a curing unit that cures the curable liquid discharged from the three-dimensional shape forming head;
a coloring head that discharges droplets of a coloring ink based on a print image to be printed on a surface of the three-dimensional object to color the three-dimensional object; and
a controller that controls operations of the three-dimensional shape forming head, the curing unit, and the coloring head,
wherein the controller prompting the three-dimensional shape forming head and the curing unit to carry out:
a layered three-dimensional object forming operation of forming and layering a plurality of layers that covers a preset region by curing the curable liquid to form a layered three-dimensional object constituting a part of the three-dimensional object, the layered three-dimensional object including steps generated by layering at least a part of the plurality of layers made of the curable liquid; and
a step coating layer forming operation of forming a layer made of the curable liquid so as to overlap the steps in the layered three-dimensional object,
the three-dimensional object being colored by the coloring head after the step coating layer forming operation performed is over.

2. The three-dimensional object shaping device as set forth in claim 1, wherein
the layered three-dimensional object forming operation forms the layered three-dimensional object including the steps corresponding to the print image.

3. The three-dimensional object shaping device as set forth in claim 1, wherein
the curable liquid is an ultraviolet curing-type ink,
the curing unit is an ultraviolet irradiator,
the three-dimensional shape forming head and the coloring head are inkjet heads that discharge ink droplets by inkjet printing,
in the layered three-dimensional object forming operation and the step coating layer forming operation, the three-dimensional shape forming head performs main scans of discharging the ink droplets while moving in a preset main scanning direction to discharge the ink droplets to positions specified by the controller.

4. The three-dimensional object shaping device as set forth in claim 1, wherein
the plurality of layers constituting the layered three-dimensional object are layered on one another in a manner that upper ones of the layers each overlap a lower layer within at least a partial region of the lower layer.

5. The three-dimensional object shaping device as set forth in claim 1, wherein
the three-dimensional shape forming head is an inkjet head that discharges droplets of at least one of a white ink and a clear ink.

6. The three-dimensional object shaping device as set forth in claim 1, wherein
the controller prompts the three-dimensional shape forming head and the curing unit to carry out, as the step coating layer forming operation, an irregularities forming operation of discharging the droplets of the curable liquid on the layered three-dimensional object based on the print image to form irregularities corresponding to the print image on the layered three-dimensional object, and
the coloring head colors the three-dimensional object after the irregularities are formed by the irregularities forming operation.

7. The three-dimensional object shaping device as set forth in claim 6, wherein
in the irregularities forming operation, the three-dimensional shape forming head forms an irregularities formation layer by discharging the droplets of the curable liquid based on the print image, and
the three-dimensional shape forming head forms and layers a plurality of the irregularities formation layers to form the irregularities corresponding to the print image on the layered three-dimensional object.

8. The three-dimensional object shaping device as set forth in claim 6, wherein
in the irregularities forming operation, the three-dimensional shape forming head carries out an operation of printing a gray-scaled image based on the print image using the curable liquid to form the irregularities corresponding to the print image on the layered three-dimensional object.

9. The three-dimensional object shaping device as set forth in claim 8, wherein
the gray-scaled image is an image obtained by subjecting the print image to gray scaling, and to tone reversal for at least a partial region of the print image.

10. The three-dimensional object shaping device as set forth in claim 6, wherein
the controller prompts the three-dimensional shape forming head and the curing unit to further carry out an irregularities covering operation of forming a layer by curing the curable liquid in a region that covers the irregularities formed in the irregularities forming operation, and
the coloring head colors the three-dimensional object after the irregularities covering operation is over.

11. A three-dimensional object shaping method of shaping a three-dimensional object that is colored, the three-dimensional object shaping method comprising uses of:
a three-dimensional shape forming head that discharges droplets of a curable liquid curable under predetermined conditions to shape the three-dimensional object;
a curing unit that cures the curable liquid discharged from the three-dimensional shape forming head; and
a coloring head that discharges droplets of a coloring ink based on a print image to be printed on a surface of the three-dimensional object to color the three-dimensional object,
wherein the three-dimensional object shaping method further comprising prompting the three-dimensional shape forming head and the curing unit to carry out:
a layered three-dimensional object forming operation of forming and layering a plurality of layers that covers a preset region by curing the curable liquid to form a layered three-dimensional object constituting a part of the three-dimensional object, the layered three-dimensional object including steps generated by layering at least a part of the plurality of layers made of the curable liquid; and
a step coating layer forming operation of forming a layer made of the curable liquid so as to overlap the steps in the layered three-dimensional object,
the three-dimensional object being colored by the coloring head after the step coating layer forming operation performed is over.
